(19) United States
(12) Patent Application Publication
(10) Pub. No.: US 2006/0029387 A1
(43) Pub. Date: Feb. 9, 2006

(54) Pressure development apparatus having a pressure roller with a non-metallic layer

(75) Inventors: Zhanjun Gao, Rochester, NY (US); Yongcai Wang, Webster, NY (US); Alphonse D. Camp, Rochester, NY (US)

Correspondence Address: Mark G. Bocchetti;Patent Legal Staff, Eastman Kodak Company, 343 State Street, Rochester, NY, 14650-2201, US

(73) Assignee: Eastman Kodak Company

(21) Appl. No.: 10/914,425

(22) Filed: Aug. 9, 2004

(51) Int. Cl. G03D 9/02

(52) U.S. Cl. 396/583

(57) ABSTRACT

A pressure development apparatus for an image forming device includes a pair of pressure roller which define a nip portion there-between for the passage of photosensitive media to be developed. The media is of the type that includes microcapsules on an imaging side thereof. The pressure roller located on the non-imaging side of the media includes a non-metallic outer layer that reduces the amount of stress on a base of the media while permitting the application of a sufficient force by the pressure roller located on the imaging side of the media to rupture selected microcapsules.

### CROSS REFERENCE TO RELATED APPLICATIONS

Reference is made to commonly-assigned U.S. patent application Ser. No. 10/687,939 filed Oct. 17, 2003, entitled IMAGING ELEMENT HAVING PROTECTIVE OVERCOAT LAYERS to Hwei-Ling Yau et. al. and Ser. No. 10/799,267 filed Mar. 12, 2004, entitled PRESSURE DEVELOPMENT APPARATUS to Zhanjun Gao, Alphonse D. Camp, Eric J. Connor and Ser. No. 10/722,248 filed Nov. 25, 2003, entitled AN IMAGE FORMING DEVICE HAVING A BRUSH TYPE PROCESSING MEMBER to Alphonse D. Camp and Zhanjun Gao.

### FIELD OF THE INVENTION

The present invention relates to a pressure development apparatus that includes a pressure roller with a non-metallic layer for processing photosensitive media; wherein the photosensitive media includes a plurality of microcapsules that encapsulate imaging material such as coloring material. The present invention further relates to an image-forming device that includes the pressure development apparatus.

### BACKGROUND OF THE INVENTION

Image forming devices are known in which media having a layer of microcapsules containing a chromogenic material and a photohardenable or photosoftenable composition, and a developer, which may be in the same or a separate layer from the microcapsules, is image-wise exposed. In these devices, the microcapsules are ruptured, and an image is produced by the differential reaction of the chromogenic material and the developer. More specifically, in these image-forming devices, after exposure and rupture of the microcapsules, the ruptured microcapsules release a color-forming agent, whereupon the developer material reacts with the color-forming agent to form an image. The image formed can be viewed through a transparent support or a protective overcoat against a reflective white support as is taught in, for example, U.S. Pat. No. 5,783,353 and U.S. Publication No. 2002/0045121 A1. Typically, the microcapsules will include three sets of microcapsules sensitive respectively to red, green and blue light and containing cyan, magenta and yellow color formers, respectively, as taught in U.S. Pat. No. 4,772,541. Preferably a direct digital transmission imaging technique is employed using a modulated LED print head to expose the microcapsules.

Conventional arrangements for developing the image formed by exposure in these image-forming devices include using spring-loaded balls, micro wheels, micro rollers or rolling pins, and heat from a heat source is applied after this development step to accelerate development.

The photohardenable composition in at least one and possibly all three sets of microcapsules can be sensitized by a photoinitiator such as a cationic dye-borate complex as described in, for example, U.S. Pat. Nos. 4,772,541; 4,772,530; 4,800,149; 4,842,980; 4,865,942; 5,057,393; 5,100,755 and 5,783,353.

The above-described imaging technology utilizes light sensitive microcapsules incorporated into a photographic coating, and produces a continuous tone digital imaging member. With regard to the media used in this technology, a substrate is coated with millions of light sensitive microcapsules, which contain either cyan, magenta or yellow image forming dyes (in leuco form). The media further comprises a monomer and the appropriate cyan, magenta or yellow photoinitiator that absorb red, green or blue light respectively. Exposure to light, after the induction period is reached, induces polymerization.

When exposure is made, the photoinitiator absorbs light and initiates a polymerization reaction, converting the internal fluid (monomer) into polymer, which binds or traps leuco dye from escaping when pressure is applied.

With no exposure, microcapsules remain soft and are easily broken, permitting all of the contained dye to be expelled into a developer containing binder and developed which produces the maximum color available. With increasing exposure, an analog or continuous tone response occurs until the microcapsules are completely hardened, to thereby prevent any dye from escaping when pressure is applied.

Conventionally, as describe above, in order to develop the image, pressure is uniformly applied across the image. As a final fixing step, heat is applied to accelerate color development and to extract all un-reacted liquid from the microcapsules. This heating step also serves to assist in the development of available leuco dye for improved image stability. Generally, pressure ruptured capsules (unhardened) expel lueco dye into the developer matrix.

Approximately 100 mega Pascal or 14,500 psi normal pressure was required for capsule crushing as documented in prior art. This need for precise application of high pressure (high compressive forces) presented a limitation to the extensibility of the conventional imaging system. Small compact low cost printers typically employed micro-wheels or balls backed by springs and operate in a scanning stylus fashion by transversing the media. This allowed for low cost and relatively low spring force due to the small surface area that the ball or micro wheel (typically 2 to 3 mm diameter) contacted on the media. The disadvantage of this method was that the processing pitch required to ensure uniform development needs to be (approximately 1 mm for a 3/16″ diameter ball) which results in slow processing times for a typical print image format (4×6 inch). Ganging multiple ball stylus or micro wheels adds cost, and increases the possibility of processing failure due to debris caught under a ball surface.

Conventional high speed processing involved line processing utilizing large crushing rollers. To ensure the high pressure, (psi) required, these rollers tended to be large to minimize deflection. However, these large rollers were costly, heavy, and require high spring loading. Again, the extensibility of this method is limited as larger rollers (and spring loads) are required as media size increases.

Recent developments in media design (or the imaging member) as described in co-pending U.S. application Ser. No. 10/687,939 have changed the prior art structure of the imaging member within the context of the present invention to the point where the aforementioned means of processing are no longer robust. The use of a substantially non-compressible top clear polymer film layer and a rigid opaque backing layer which serves to contain the image forming layer of conventional media presented a processing position whereby balls, micro wheels or rollers could be used with minimized processing artifacts such as scratch, banding, or dimensional or surface deformation. In addition, the non-compressibility of this prior art structure provided more tolerance to processing conditions.

The recent imaging member embodiment as described in the above-mentioned co-pending patent application, replaces the top and bottom structures of the media with more compressible materials, for example, a gelatin based protective overcoat and a filled polyolefin paper base. The media as described in the above-mentioned co-pending application no longer survive these means of processing in a robust fashion where pressure is applied by a roller or ball. This is due to the fact that in the imaging member described in the co-pending application, the polyolefin paper backing that is used as fiber base substrates (cellulose fiber) present non uniform density, and the compression forces required for processing in the conventional arrangements may make an “image” of the fiber pattern in the print, thus making the print corrupt.

It would be advantageous to provide a means or method of processing that did not invoke present methods utilizing high compression forces to provide a high quality image by improving the tonal scale development and density minimum formation of the imaging member. As mentioned, the need to provide a means of processing that will facilitate the use of the recently designed imaging member is needed. In addition, a processing means that would use plain paper as a substrate would be highly desired. Further, it would be advantageous to provide a means of processing that is low in cost, is fully extensible, and is mechanically simple and robust.

The rollers for conventional pressure development apparatuses utilized hard metallic rollers or balls as the processing rollers (balls) on both sides of the media to deliver high stress to the microcapsules. Since the required stress to rupture the microcapsules are rather high, significant stress or deformation are also observed in the media support. As a result of such high stress or deformation, defects in the media support can be seen on the image side of the media as random patterns that compromise the quality of the image.

### SUMMARY OF THE INVENTION

An object of the present invention is to eliminate or reduce the unwanted random pattern from the image by reducing the stress on the media support while maintaining the required high stress on the microcapsule. The present invention provides for a pressure development apparatus that includes a roller pair wherein one of the roller pair is a backing roller that includes a non-metallic layer such as a polymer layer. The arrangement of the present invention enables the application of pressure to development a latent image on microencapsulated media in a manner in which the stress on the media support is reduced while the pressure on the imaging side of the media is sufficient to enable the development of the latent image.

The present invention relates to a pressure development apparatus that comprises a first pressure roller adapted to contact an imaging side of photosensitive media containing microcapsules; and a second pressure roller which is located opposite the first pressure roller so as to define a nip portion for a passage of media there-between, with the second pressure roller comprising a non-metallic outer layer that is adapted to contact a non-imaging side of the media, and the passage of the media through the nip portion causing an application of pressure onto the imaging side of the media to rupture selected microcapsules and cause a development of a latent image on the media.

The present invention further relates to an image forming device the comprises an imaging member adapted to expose a photosensitive medium to form a latent image on the photosensitive medium, with the photosensitive medium comprising a plurality of microcapsules which encapsulate imaging material; and a pressure development apparatus comprising a first pressure roller adapted to contact an imaging side of the photosensitive medium, and a second pressure roller which is located opposite the first pressure roller so as to define a nip portion for a passage of the medium there-between. The second pressure roller comprises a non-metallic outer layer that is adapted to contact a non-imaging side of the medium, and the passage of the medium through the nip portion causing an application of pressure onto the imaging side of the media to rupture selected microcapsules and cause a development of the latent image on the medium.

The present invention also relates to an image forming method that comprises exposing a photosensitive medium comprising a plurality of micro-capsules which encapsulate imaging material to form a latent image; and developing the latent image by passing the medium through a nip portion defined by a first pressure roller adapted to contact an imaging side of the photosensitive medium that contains that microcapsules, and a second pressure roller which is located opposite the first pressure roller. The second pressure roller comprises a non-metallic outer layer that is adapted to contact a non-imaging side of the medium, such that the passage of the medium through the nip portion causes an application of pressure onto the imaging side of the medium to rupture selected microcapsules and cause a development of the latent image on the medium.

### BRIEF DESCRIPTION OF THE DRAWINGS

FIG. 1A schematically shows an image-forming device;

FIG. 1B schematically shows an example of a pressure applying system that can be used in the image-forming device of FIG. 1;

FIG. 2 is an embodiment of a pressure development apparatus in accordance with the present invention;

FIG. 3 is a graph showing the relationship between stress applied to the imaging layer of media and stress applied to the base layer; and

FIG. 4 is a graph showing the stress reduction in the base or support layer of the media.

### DETAILED DESCRIPTION OF THE INVENTION

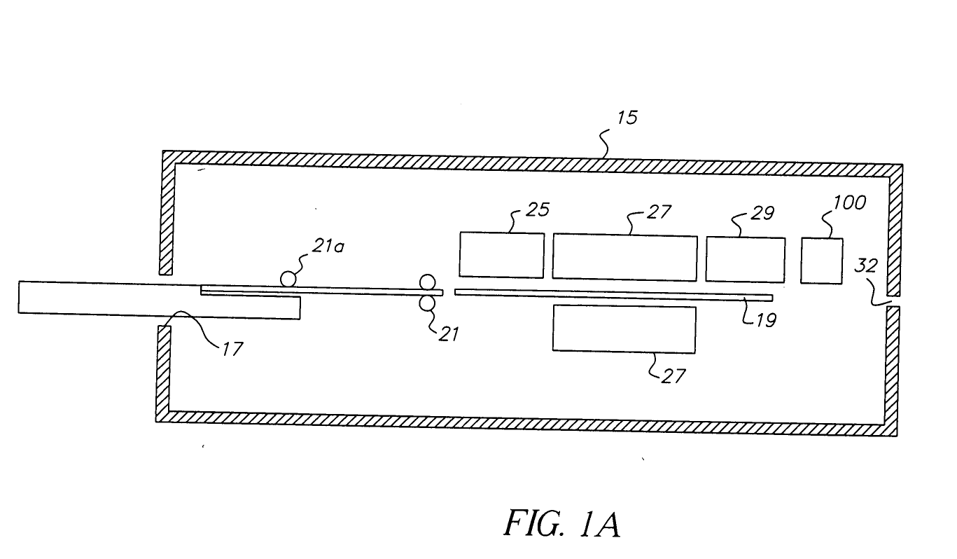

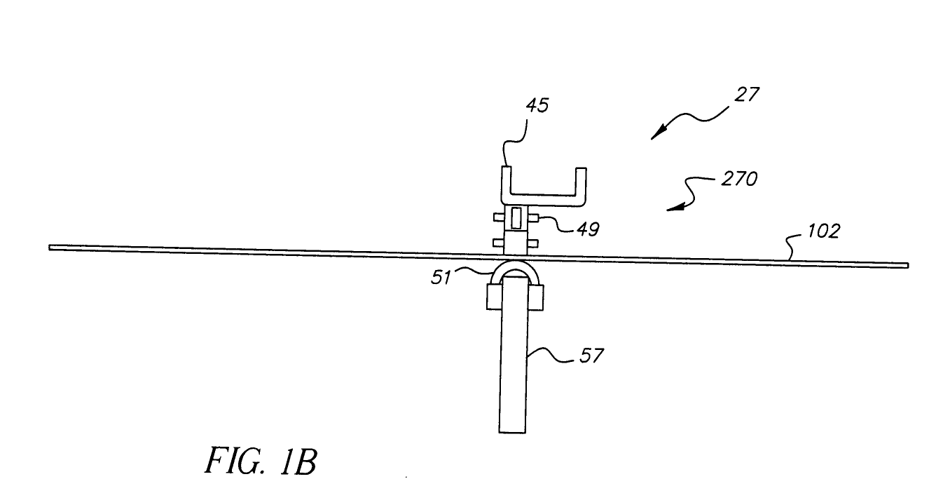

Referring now to the drawings, wherein like reference numerals represent identical or corresponding parts throughout the several views, FIG. 1A is a schematic view of an image-forming device 15 pertinent to the present invention. Image forming device 15 could be, for example, a printer that includes an opening 17 that is adapted to receive a cartridge containing photosensitive media. As described in U.S. Pat. No. 5,884,114, the cartridge could be a light tight cartridge in which photosensitive sheets are piled one on top of each other. When inserted into image forming device 15, a feed mechanism that includes, for example, a feed roller 21a in image forming device 15, working in combination with a mechanism in the cartridge, cooperate with each other to pull one sheet at a time from the cartridge into image forming device 15 in a known manner. Although a cartridge type arrangement is shown, the present invention is not limited thereto. It is recognized that other methods of introducing media into to the image-forming device such as, for example, individual media feed or roll feed are applicable to the present invention.

Once inside image forming device 15, photosensitive media travels along media path 19, and is transported by, for example, drive rollers 21 connected to, for example, a driving mechanism such as a motor. The photosensitive media will pass by an imaging member 25 in the form of an imaging head that could include a plurality of light emitting elements (LEDs) that are effective to expose a latent image on the photosensitive media based on image information. After the latent image is formed, the photosensitive media is conveyed past a processing assembly or a development member 27. Processing assembly 27 could be a pressure applicator or pressure assembly, wherein an image such as a color image is formed based on the image information by applying pressure to microcapsules having imaging material encapsulated therein to crush the microcapsules. The pressure could be applied by way of spring-loaded balls, micro wheels, micro rollers, rolling pins, etc.

FIG. 1B schematically illustrates an example of a pressure applicator 270 for processing assembly 27 which can be used in the image-forming device of FIG. 1A. In the example of FIG. 1B, pressure applicator 270 is a crushing roller arrangement that provides a point contact on photosensitive medium 102. More specifically, pressure applicator 270 includes a support 45 that extends along a width-wise direction of photosensitive medium 102. Moveably mounted on support 45 is a crushing roller arrangement 49 that is adapted to move along the length of support 45, i.e., across the width of photosensitive medium 102. Crushing roller arrangement 49 is adapted to contact one side of photosensitive medium 102. A beam or roller type member 51 is positioned on an opposite side of photosensitive medium 102 and can be provided on a support or spring member 57. Beam or roller type member 51 is positioned so as to contact the opposite side of photosensitive medium 102 and is located opposite crushing roller arrangement 49. Beam or roller type member 51 and crushing roller arrangement 49 when in contact with photosensitive medium 102 on opposite sides provide a point contact on photosensitive medium 102. Crushing roller arrangement 49 is adapted to move along a width-wise direction of photosensitive material 102 so as to crush microcapsules and release coloring material. Further examples of pressure applicators or crushing members that can be used in the image-forming device of FIG. 1A are described in U.S. Pat. Nos. 6,483,575 and 6,229,558.

Within the context of the present invention, the imaging material comprises a coloring material (which is used to form images) or material for black and white media. After the formation of the image, the photosensitive media is conveyed past heater 29 (FIG. 1A) for fixing the image on the media. In a through-feed unit, the photosensitive media could thereafter be withdrawn through an exit 32. As a further option, image-forming device 15 can be a return unit in which the photosensitive media is conveyed or returned back to opening 17.

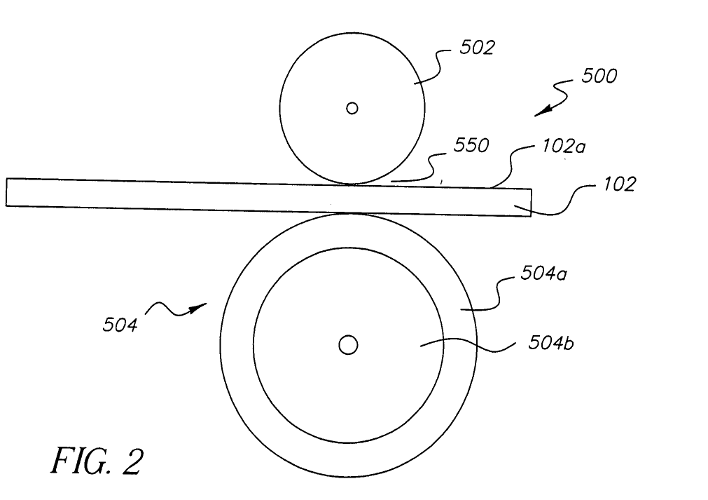

A preferred embodiment of a pressure development apparatus in accordance with the present invention is shown in FIG. 2. Pressure development apparatus 500 as shown in FIG. 2 can be utiltized in assembly 27 illustrated in FIG. 1B. Apparatus 500 comprises a first pressure roller or ball 502 which is a top roller that is adapted to contact an imaging side of photosensitive media 102 that contains microcapsules. Apparatus 500 further comprises a second pressure roller or ball 504 which is a backing roller and is located opposite first pressure roller 502 so as to define a nip portion 550 for the passage of media 102 there-between. The second pressure roller 504 comprises a non-metallic outer layer 504a that is adapted to contact a non-imaging side or back side of media 102. With the arrangement of FIG. 2, the passage of the media 102 through the nip portion 550 causes an application of pressure onto imaging side 102a of the media 102 to rupture selected microcapsules and cause a development of a latent image on the media.

In a feature of the present invention, non-metallic outer layer 504a is preferably a polymer layer that surrounds a core 504b that can optionally be a metallic core. Also, the first pressure roller 502 is preferably a metallic roller.

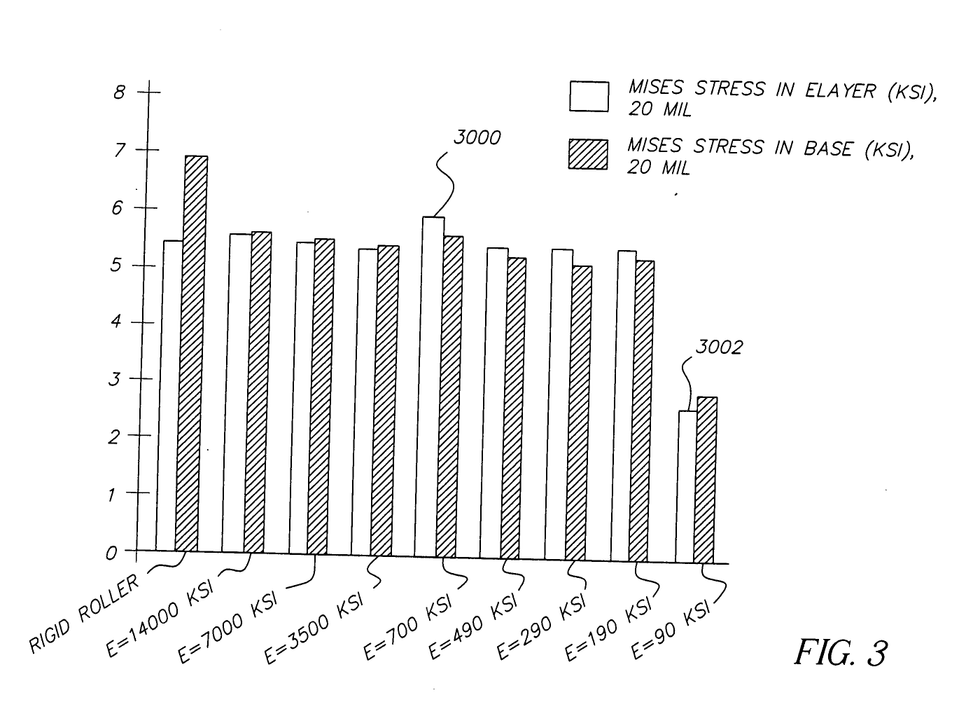

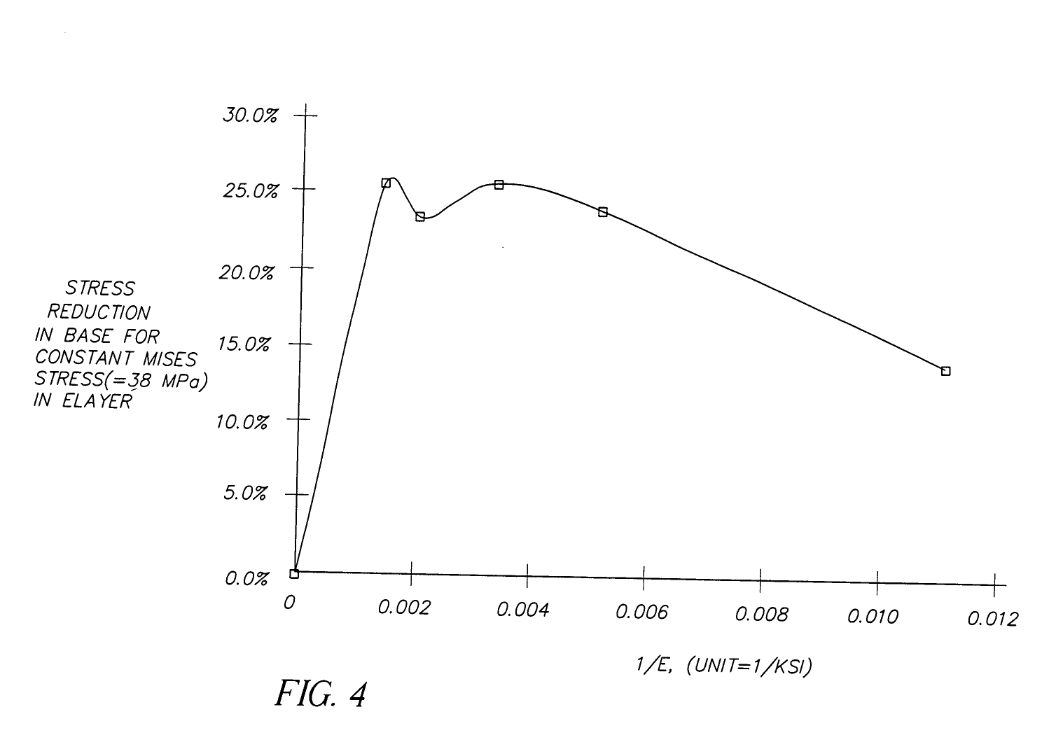

Therefore, in a preferred arrangement of the present invention, the imaging side 102a of the media 102 that contains the microcapsules faces the top processing roller (ball) 502. The bottom processing roller (ball) 504 contains nonmetallic layer 504a with an optional metal core 504b. The nonmetallic layer 504a preferably has a Young's modulus of elasticity from 190 ksi to 700 ksi, (wherein ksi=kilo−lb/in²=1000 lb/in²) that is stiffer than rubber and close to the Young's modulus of many engineering plastics such as PET (polyethylene terephtalate), PEN (polyethylene naphthalate), PMMA (polymethyl mathacylate), etc. The advantage of the present invention is illustrated by the graphs of FIGS. 3 and 4.

FIG. 3 represents a graph that shows the relationship between the application of stress to the media support (vertical axis) and the Modulus of Elasticity of the bottom roller (horizontal axis).

As shown in FIG. 3, when utilizing a roller 504 in accordance with the present invention where the non-metallic layer 504a preferably has a modulus of between 190 ksi and 1400 ksi, a stress level of 5.4 ksi in the imaging layer (elayer) 102a (the layer that contains the microcapsules) can be maintained while the stress on the base layer can be reduced from close to 7 ksi (when using a rigid bottom roller) to 5.2 ksi. This reduces or eliminates any imperfection caused by the creation of random patterns in the base layer due to a large amount of stress being applied to the base layer. It should be pointed out that when the bottom roller is metal (rigid), the maximum stress in the media support is higher than that in the imaging layer 102a as shown in FIG. 3. The “von Mises” stress of FIGS. 3 and 4 is a stress value derived from the 3-dimensional stress components, and is often used as the metric for evaluating failure of a structural or material component (Mechanical Engineering Design, by J. E. Shigley and C. R. Mischke, Fifth edition, McGraw-Hill Book Company, New York, 1989, Chapter 6). In the examples shown here, the normal pressure in different layers of the media 102 exhibits the same trend shown in FIGS. 3 and 4.

Therefore, when the bottom roller is made of material with Young's modulus of, for example, 700 ksi (such as PET), enough of a cushioning effect is provided to reduce the stress in the media support or base layer to a level lower than that in the layer with the microcapsules (see reference numeral 3000 in FIG. 3). This is also true for cases in which the bottom roller has a Young's modulus at 490 ksi, 290 ksi and 190 ksi as shown in FIG. 3. Furthermore, if the bottom roller is too soft (e.g., E=90 ksi), the stress in the imaging layer is lower than that in the media support (see reference numeral 3002 in FIG. 3). This would not be preferable within the context of the present invention.

The graph of FIG. 4 illustrates the stress reduction in the media support that can be achieved with the present invention. With the arrangement of the present invention, the bottom roller 504 with the elastic layer 504a as describe above permits the reduction of the maximum stress in the media support with sacrificing the stress needed to rupture the microcapsules. As shown in FIG. 4, with the arrangement of the present invention, it is possible to reduce the maximum stress in the media support by as much as 25% while achieving a constant stress level in the imaging layer with the microcapsules.

The invention has been described in detail with particular reference to certain preferred embodiments thereof, but it will be understood that variations and modifications can be effected within the spirit and scope of the invention.

1. A pressure development apparatus comprising:
a first pressure roller adapted to contact an imaging side of photosensitive media containing microcapsules; and
a second pressure roller which is located opposite said first pressure roller so as to define a nip portion for a passage of media there-between, said second pressure roller comprising a non-metallic outer layer which is adapted to contact a non-imaging side of said media, wherein the passage of the media through said nip portion causes an application of pressure onto said imaging side of said media to rupture selected microcapsules and cause a development of a latent image on said media.

2. A pressure development apparatus according to claim 1, wherein said second pressure roller comprises a metallic core and said non-metallic outer layer surrounds said metallic core.

3. A pressure development apparatus according to claim 1, wherein said non-metallic outer layer is a polymer layer.

4. A pressure development apparatus according to claim 2, wherein said non-metallic outer layer is a polymer layer.

5. A pressure development apparatus according to claim 3, wherein said polymer layer has a Young's Modulus of elasticity at least within the range of 190 ksi to 1400 ksi.

6. A pressure development apparatus according to claim 1, wherein said first pressure roller is a metallic roller.

7. An image forming device comprising:
an imaging member adapted to expose a photosensitive medium to form a latent image on the photosensitive medium, the photosensitive medium comprising a plurality of microcapsules which encapsulate imaging material; and
a pressure development apparatus comprising a first pressure roller adapted to contact an imaging side of said photosensitive medium, and a second pressure roller which is located opposite said first pressure roller so as to define a nip portion for a passage of the medium there-between, said second pressure roller comprising a non-metallic outer layer which is adapted to contact a non-imaging side of said medium, wherein the passage of the medium through said nip portion causes an application of pressure onto said imaging side of said media to rupture selected microcapsules and cause a development of the latent image on said medium.

8. An image forming device according to claim 7, wherein said second pressure roller comprises a metallic core and said non-metallic outer layer surrounds said metallic core.

9. An image forming device according to claim 7, wherein said non-metallic outer layer is a polymer layer.

10. An image forming device according to claim 8, wherein said non-metallic outer layer is a polymer layer.

11. An image forming device according to claim 10, wherein said polymer layer has a Young's Modulus of elasticity at least within the range of 190 ksi to 700 ksi.

12. An image forming device according to claim 7, wherein said first pressure roller is a metallic roller.

13. An image forming method comprising:
exposing a photosensitive medium comprising a plurality of micro-capsules which encapsulate imaging material to form a latent image; and
developing the latent image by passing the medium through a nip portion defined by a first pressure roller adapted to contact an imaging side of said photosensitive medium that contains said microcapsules, and a second pressure roller which is located opposite said first pressure roller, said second pressure roller comprising a non-metallic outer layer which is adapted to contact a non-imaging side of said medium, wherein the passage of the medium through said nip portion causes an application of pressure onto said imaging side of said medium to rupture selected microcapsules and cause a development of the latent image on said medium.

14. An image forming method according to claim 13, wherein said second pressure roller comprises a metallic core and said non-metallic outer layer surrounds said metallic core.

15. An image forming method according to claim 13, wherein said non-metallic outer layer is a polymer layer.

16. An image forming device according to claim 14, wherein said non-metallic outer layer is a polymer layer.

17. An image forming device according to claim 13, wherein said polymer layer has a Young's Modulus of elasticity at least within the range of 190 ksi to 1400 ksi.

18. An image forming device according to claim 13, wherein said first pressure roller is a metallic roller.
